(19) United States
(12) Patent Application Publication
(10) Pub. No.: US 2018/0077252 A1
(43) Pub. Date: Mar. 15, 2018

(54) INFLUENCE CALCULATION PROGRAM AND INFLUENCE CALCULATION DEVICE

(71) Applicant: Konica Minolta, Inc., Tokyo (JP)

(72) Inventor: Nobuhiro NOJIMA, Tokyo (JP)

(21) Appl. No.: 15/686,309

(22) Filed: Aug. 25, 2017

(30) Foreign Application Priority Data
Sep. 12, 2016 (JP) 2016-177401

(51) Int. Cl. H04L 29/08; G06Q 10/10

(52) U.S. Cl. CPC H04L 67/22; H04L 67/306; G06Q 10/107

(57) ABSTRACT

A non-transitory recording medium storing a computer readable influence calculation program causes a computer to perform: acquiring a first communication history between a first person and a second person; acquiring a second communication history between the second person and a third person; and calculating an influence score of the first person on a plurality of persons including the second person and the third person, in accordance with information including the first communication history and the second communication history.

Japanese Patent Application No. 2016-177401 filed on Sep. 12, 2016, including description, claims, drawings, and abstract the entire disclosure is incorporated herein by reference in its entirety.

### BACKGROUND

### Technological Field

The present disclosure relates to an influence calculation program and an influence calculation device.

### Description of the Related art

Normally, how information spreads across an entire organization varies depending on which one of the persons belonging to the organization the information is transmitted to. In a case where a person wishes to transmit information across the organization, for example, if the respective roles of the persons belonging to the organization are apparent, it is possible to recognize to which one of the persons the information should be transmitted so as to appropriately transmit the information across the organization. JP 2006-155421 A discloses a method of estimating the characteristics of the subject person among the persons, using the e-mail communication history of the subject person. According to JP 2006-155421 A, the characteristics indicate that the subject person is a leader, or the subject person is a loner, for example. A person can recognize that it is possible to appropriately transmit information across the organization by transmitting the information to a person having the characteristics of a leader.

According to the invention disclosed in JP 2006-155421 A, however, only the communication history between the subject person and a person who has communicated with the subject person is used, and therefore, the influence score of the subject person on other persons cannot be accurately calculated, with the characteristics of the subject person being an example.

### SUMMARY

The present disclosure has been made in view of such circumstances, and an object thereof is to provide an influence calculation program and an influence calculation device.

To achieve the abovementioned object, according to an aspect of the present invention, a non-transitory recording medium storing a computer readable influence calculation program reflecting one aspect of the present invention causes a computer to perform: acquiring a first communication history between a first person and a second person; acquiring a second communication history between the second person and a third person; and calculating an influence score of the first person on a plurality of persons including the second person and the third person, in accordance with information including the first communication history and the second communication history.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram for explaining an example configuration of an influence calculation system according to an embodiment;

FIG. 2 is a diagram showing the hardware configuration of an influence calculation device;

FIG. 3 is a diagram showing the hardware configuration of a display device;

FIG. 4 shows an example of a mail DB;

FIG. 5 is a diagram showing the functional configuration of the influence calculation device;

FIG. 6 is a table showing an example of a relationship list;

FIG. 7 is a table showing an adjacency matrix;

FIG. 8 is a diagram showing the contents of the adjacency matrix;

FIG. 9 is a diagram showing generations in a case where a first person is a person B;

FIG. 10 is a diagram showing coefficients in a case where the first person is the person B;

FIG. 11 is a diagram showing influence scores of respective persons;

FIG. 12 is a table showing an influence score DB;

FIG. 13 shows a flowchart of a process to be performed by the influence calculation device;

FIG. 14 shows a flowchart of a relationship list generation process;

FIG. 15 is a diagram showing an example of the input screen of the display device;

FIG. 16 is a diagram showing an example of the influence score display screen of the display device;

FIG. 17 shows a flowchart of a process to be performed by the display device;

FIG. 18 shows a flowchart of a process to be performed by an influence calculation device according to a second embodiment;

FIG. 19 is a diagram showing the concept of betweenness centrality;

FIG. 20 is a table showing communication histories of respective persons in another embodiment;

FIG. 21 is a table showing a relationship list of another embodiment;

FIG. 22 is a table showing an adjacency matrix of another embodiment;

FIG. 23 is a table showing an adjacency matrix of another embodiment;

FIG. 24 is a table showing an adjacency matrix of another embodiment;

FIG. 25 is a table showing an adjacency matrix of another embodiment;

FIG. 26 is a table showing an influence score DB of another embodiment;

FIG. 27 is a table showing other names of respective influence scores;

FIG. 28 is a diagram showing an example of the input screen of a display device of another embodiment; and

FIG. 29 is a diagram showing an example of the influence score display screen of the display device of another embodiment.

### DETAILED DESCRIPTION OF EMBODIMENTS

Hereinafter, one or more embodiments of the present invention will be described with reference to the drawings. However, the scope of the invention is not limited to the disclosed embodiments. In the description below, like components and constituent elements are denoted by like reference numerals. Like components and constituent elements also have like names and functions. Therefore, explanation of them will not be repeated.

### First Embodiment

<Influence Calculation System 20>

FIG. 1 is a diagram for explaining an example configuration of an influence calculation system 20 according to this embodiment. The influence calculation system 20 includes a mail server 2, a collection device 4, a database (DB) 6, an influence calculation device 8, and a display device 10.

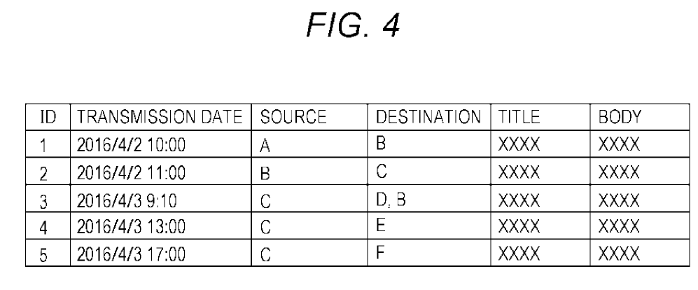

The mail server 2 is connected to another mail server (not specifically shown). The mail server 2 transmits/receives electronic mail to/from this mail server. The collection device 4 collects mail information from the mail server 2 on a regular basis (every month, for example), and stores the mail information into the DB 6. Here, the mail information includes transmission dates, sources, destinations, titles, and message bodies of electronic mail, as shown in FIG. 4. The DB 6 stores various kinds of information, as well as the mail information.

The influence calculation device 8 calculates the influence score of a subject person on other persons. The display device 10 displays the calculated influence score. The display device 10 may be a device such as a personal computer (PC), a smartphone, or a tablet. In this embodiment, the influence calculation device 8 and the display device 10 are formed with different housings from each other. In a modification, the influence calculation device 8 and the display device 10 may be integrally formed.

<Hardware Configuration of the Influence Calculation Device 8>

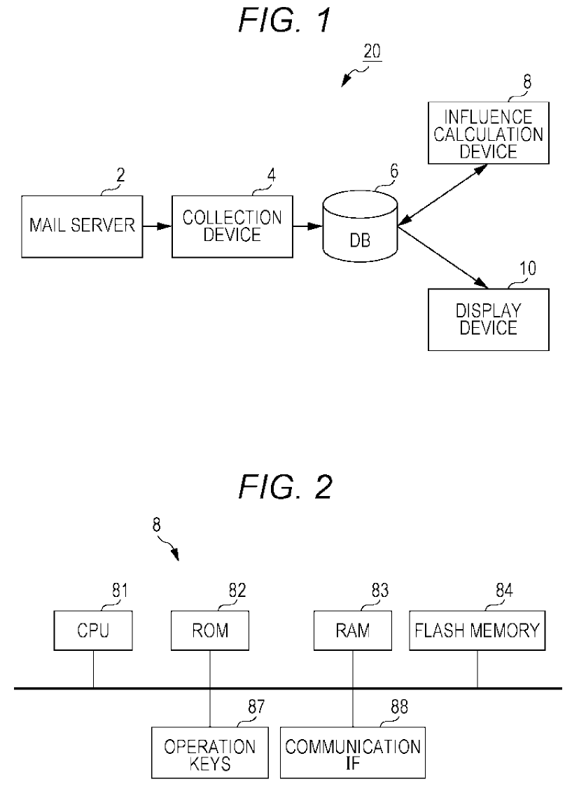

FIG. 2 is a diagram showing the hardware configuration of the influence calculation device 8. As shown in FIG. 2, the influence calculation device 8 includes a central processing unit (CPU) 81 that executes programs, a read only memory (ROM) 82 that stores data in a nonvolatile manner, a random access memory (RAM) 83 that stores data in a volatile manner, a flash memory 84, operation keys 87 that accept instruction inputs from the user of the influence calculation device 8 (the user being the manager of the influence calculation system 20, for example), and a communication interface (IF) 88.

The flash memory 84 is a nonvolatile semiconductor memory. The flash memory 84 stores the operating system and various kinds of programs to be executed by the CPU 81, and various kinds of content and data. The flash memory 84 also stores various kinds of data, such as data generated by the influence calculation device 8 and data obtained from a device outside the influence calculation device 8, in a volatile manner.

<Hardware Configuration of the Display Device 10>

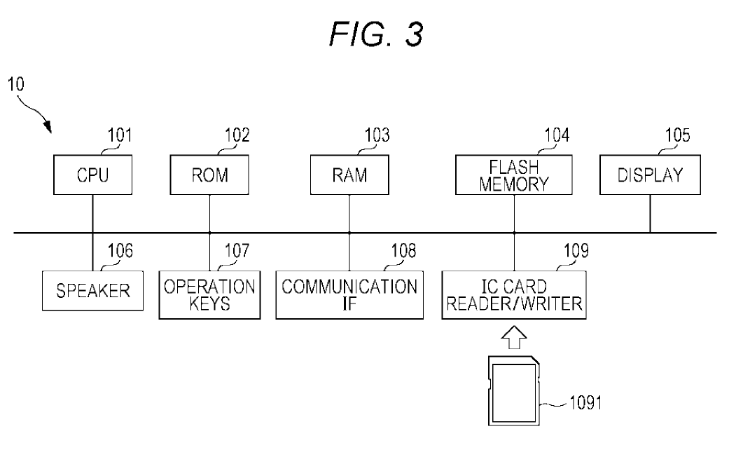

FIG. 3 is a diagram showing the hardware configuration of the display device 10. As shown in FIG. 3, the display device 10 includes a CPU 101 that executes programs, a ROM 102 that stores data in a nonvolatile manner, a RAM 103 that stores data in a volatile manner, a flash memory 104, a display 105, operation keys 107 that accept instruction inputs from the user of the display device 10, and a communication interface (IF) 108.

The display 105 displays various kinds of information in accordance with instruction inputs from the user of the display device 10. The flash memory 104 is a nonvolatile semiconductor memory. The flash memory 104 stores the operating system and various kinds of programs to be executed by the CPU 101, and various kinds of content and data. The flash memory 104 also stores various kinds of data, such as data generated by the display device 10 and data obtained from a device outside the display device 10, in a volatile manner.

<Influence Scores>

FIG. 4 shows an example of a mail DB that is a DB included in the DB 6 and stores mail information. In the example shown in FIG. 4, a mail information ID is assigned to each set of mail information. As for the mail information with a mail ID “1” in the example shown in FIG. 4, the mail transmission date is 10 o'clock on Apr. 2, 2016, the source is a person A, and the destination is a person B. In FIG. 4, “xxxx” is shown as the title and the message body. In reality, however, the text of the title and the text of the message body of the e-mail transmitted from the person A to the person B are stored in the mail DB. In the example shown in FIG. 4, persons are written as the sources and the destinations, but the transmitters that transmit e-mail and the receivers that receive e-mail are terminals owned by the persons. As for the mail information with the mail ID “1”, for example, the source is a terminal owned by the person A, and the destination is a terminal owned by the person B.

The influence calculation device 8 of this embodiment calculates respective influence scores of the six persons, or the persons A through F, which are shown as the sources and the destinations in FIG. 4. Next, influence scores are described. The influence calculation device 8 of this embodiment calculates the influence score of a subject person on the other persons (or the other five persons) among the six persons. In a case where the subject person is A, for example, the influence calculation device 8 calculates the influence score of the person A on the persons B through F. In this embodiment, the persons A through F belong to a predetermined group. A group is a concept such as a company, an organization, or a department.

An influence score may be a value that indicates how well information can be transmitted to all the persons belonging to the group when communication with a person is made (or the information is transmitted to the person). In view of this, an influence score is also called a communication value. Also, an influence score may be a value that indicates how much all the persons belonging to the group are influenced when communication with a person is made (or information is transmitted to the person). Here, the information to be transmitted may be information to be transmitted via electronic mail, information to be transmitted orally, or information to be transmitted in writing. Also, an influence score may be a value that indicates how much all the persons belonging to the group can be influenced.

In the example case described below, a person M who does not know the persons A through F wishes to transmit information to all the persons belonging to the group. If the person M recognizes the respective influence scores of the persons A through F in this case, the person M can realize that it is possible to transmit information smoothly to each of the persons A through F by transmitting the information to the person with the highest influence score. Also, in a case where the person M wishes to consult about his/her worries or the like, the person M can realize that the possibility of solving his/her worries is higher when the person M consults the person with the highest influence score than when the person M consults some other person among the persons A through F. As described above, even in a case where the person M does not know the persons A through F, the person M can recognize the respective influence scores of the persons A through F, so that the convenience in transmitting information to the persons A through F can be increased, for example.

<Functional Configuration of the Influence Calculation Device 8>

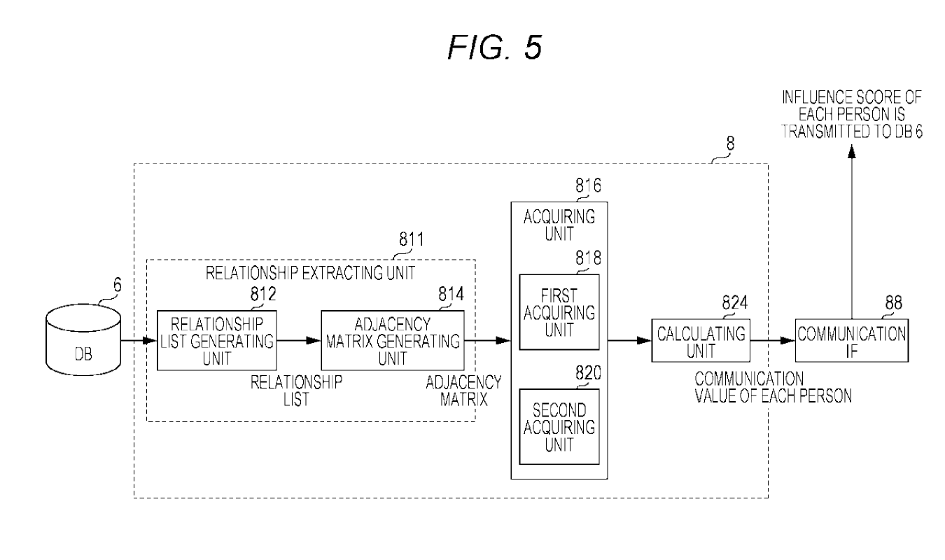

FIG. 5 is a functional block diagram for explaining the functional configuration of the influence calculation device 8. As shown in FIG. 5, the influence calculation device 8 includes an acquiring unit 816, a relationship extracting unit 811, and a calculating unit 824. The acquiring unit 816 includes a first acquiring unit 818 and a second acquiring unit 820. The relationship extracting unit 811 includes a relationship list generating unit 812 and an adjacency matrix generating unit 814.

The relationship extracting unit 811, the acquiring unit 816, and the calculating unit 824 are formed through arithmetic processing performed by the CPU 81.

<<Relationship List Generating Unit 812>>

The relationship list generating unit 812 acquires mail information equivalent to a predetermined period T (three months, for example) from the DB 6. Here, the mail information acquired by the relationship list generating unit 812 in the predetermined period T is the mail information shown in FIG. 4. In the description below, in a case where a person 0 and a person P have communicated with each other in the past predetermined period T, “the person 0 and the person P have a relationship”. Here, communicating includes both transmitting information and receiving information. Meanwhile, the information includes e-mail and messages. In a case where the person 0 and the person P have not communicated with each other through e-mail in the past predetermined period T, on the other hand, “the person 0 and the person P do not have any relationship”.

The relationship list generating unit 812 generates a relationship list by determining whether there is a relationship with each person from the acquired mail information. From the mail information, the relationship list generating unit 812 extracts the relationships with the persons with whom e-mail has been exchanged, for example. The relationship list generating unit 812 determines that “a person who has transmitted e-mail and a person who has received the transmitted e-mail” are “persons who have exchanged e-mail”. In this manner, the relationship list generating unit 812 sets a pair of the persons who have exchanged the e-mail. If there are more than one destination from the source, the relationship with the destinations are extracted.

In the description below, e-mail transmission from the person A to the person B is shown as “A→B”. As for the mail ID “3” in FIG. 4, for example, the relationship list generating unit 812 determines that there are the two kinds of relationships, “C→D” and “C→B”. The relationship list generating unit 812 of this embodiment does not take into consideration which one of the persons who have exchanged e-mail is the source or the destination. Specifically, in FIG. 4, there are the relationship “B→C” and the relationship “C→B”. However, the relationship list generating unit 812 regards these relationships as identical, and determines that there is a relationship between B and C.

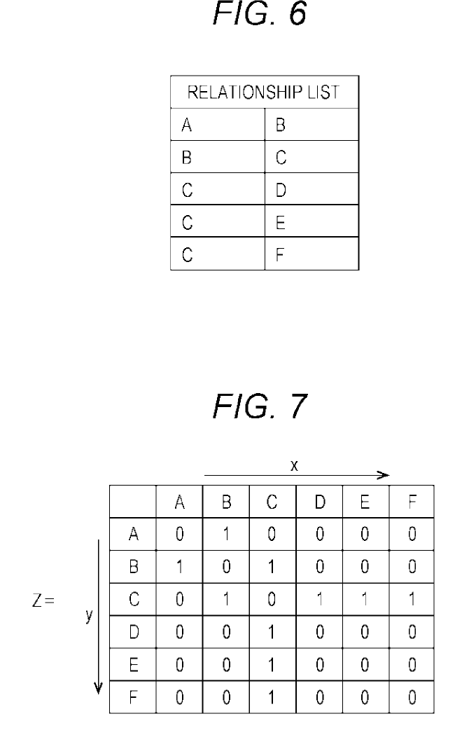

FIG. 6 shows an example of a relationship list generated by the relationship list generating unit 812. By the above described determination method, the relationship list generating unit 812 generates the relationship list shown in FIG. 6 from the mail information shown in FIG. 4. As can be seen from the example shown in FIG. 6, there are relationships between the person A and the person B, the person B and the person C, the person C and the person D, the person C and the person E, and the person C and the person F. The relationship list generating unit 812 transmits the generated relationship list to the adjacency matrix generating unit 814.

<<Adjacency Matrix Generating Unit 814>>

The adjacency matrix generating unit 814 generates an adjacency matrix Z in accordance with the relationship list. The adjacency matrix Z is a matrix indicating the relationships between the persons who have communicated with each other through e-mail (exchanged e-mail with each other) in the predetermined period T. The row and column sizes of the adjacency matrix Z are determined by the number of persons whose influence scores are to be calculated. In a case where the number of persons whose influence scores are to be calculated is N (N being a natural number), the adjacency matrix Z is an N-by-N matrix. Since the number of persons whose influence scores are to be calculated is six (the persons A through F), a 6-by-6 matrix is generated as the adjacency matrix Z. The adjacency matrix Z is shown below.

$$[ Mathematical Formula 1 ]$$

$$Z = [ \begin{matrix}0 & 1 & 0 & 0 & 0 & 0 \\ 1 & 0 & 1 & 0 & 0 & 0 \\ 0 & 1 & 0 & 1 & 1 & 1 \\ 0 & 0 & 1 & 0 & 0 & 0 \\ 0 & 0 & 1 & 0 & 0 & 0 \\ 0 & 0 & 1 & 0 & 0 & 0\end{matrix} ]$$

FIG. 7 shows the adjacency matrix Z in the form of a table. In the example shown in FIG. 7, the persons A through F are assigned to the respective rows and the respective columns. In the example shown in FIG. 7, “1” at each portion where a person shown as a column component and a person shown as a row component cross each other indicates that these persons have communicated with each other through e-mail in the predetermined period T (or have a relationship). On the other hand, “0” at each portion where a person shown as a column component and a person shown as a row component cross each other indicates that these persons have not communicated with each other through e-mail in the predetermined period T (or have no relationship).

For example, since the portion where the person A and the person B cross each other shows “1”, there is a relationship between the person A and the person B (also see FIG. 6). Meanwhile, since the portion where the person A and the person C cross each other shows “0”, there is no relationship between the person A and the person C (also see FIG. 6). In FIG. 7 and the adjacency matrix Z, the portion where the person A in the row direction and the person A in the column direction cross each other is the origin, each component in the x-axis direction is an x-component, and each component in the y-axis direction is a y-component. For example, in FIG. 7, (3, 4) as a component (x, y) is “1”, which indicates that there is a relationship between the person C and the person D. The adjacency matrix Z generated by the adjacency matrix generating unit 814 is input to the calculating unit 824.

<<Calculating Unit 824>>

The calculating unit 824 calculates the influence score of each of the persons A through F in accordance with the adjacency matrix Z. FIG. 8 is a diagram showing the contents of the adjacency matrix Z. In FIG. 8, each circle represents a person (a node), and each line indicates a relationship. For example, the person A has a relationship with the person B, but has no relationship with each of the persons C through F. Also, the person C has a relationship with the person B and a relationship with each of the persons D through F, but has no relationship with the person A. Hereinafter, the subject person whose influence score is to be calculated will be referred to as a “first person”. A person who has communicated with the first person within the predetermined period T will be referred to as a “second person”. A person who has communicated with the second person within the predetermined period T will be referred to as a “third person”. A person who has communicated with a certain person within the predetermined period T will be referred to as a communication person. Further, a diagram showing exchanges of e-mail as shown in FIG. 8 will also be referred to as a network.

Where the calculating unit 824 calculates influence scores, a concept of “generation” is used. A generation indicates closeness to the first person. From the viewpoint of the first person, the generation of the first person is “0”. From the viewpoint of the first person, the generation of a second person is “1”. From the viewpoint of the first person, the generation of a third person is “2”. In a case where the first person is the person B, for example, the person A and the person C are second persons, and the person D, the person E, and the person F are third persons.

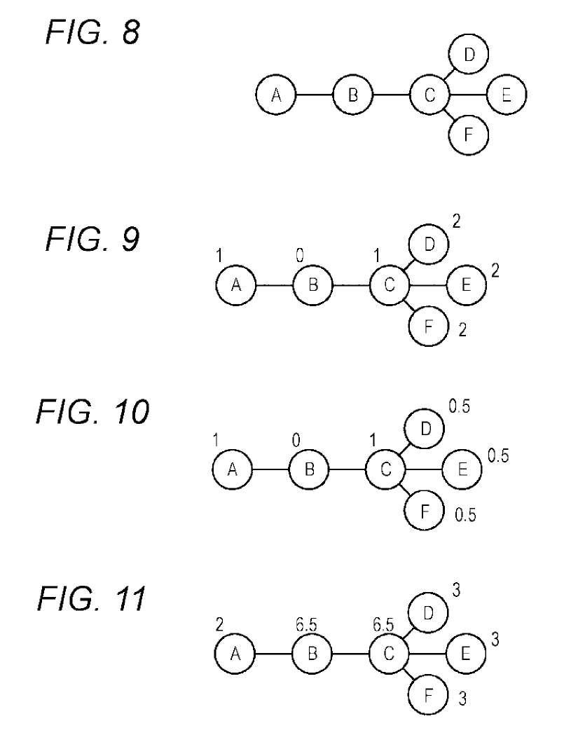

FIG. 9 shows the generations in a case where “the first person whose influence score is to be calculated by the calculating unit 824” is the “person B”. In this case, the generation G of the person B is “0”, the generation G of each of the persons A and C is “1”, and the generation G of each of the persons D through F is “2”. Each person of the generation “1” is also called a first-generation person, and each person of the generation “2” is also called a second-generation person.

Next, the set of N (six in this embodiment) persons specified in the relationship list is defined as shown below.

X=(X₁,X₂,X₃, . . . ,X_{N})

N is a natural number. In this embodiment, X₁ represents the person A, X₂ the person B, X₃ the person C, X₄ the person D, X₅ the person E, and X₆ the person F. Using Equation 1 shown below, the calculating unit 824 calculates the influence score of a person X,. Here, 1≦i≦N, and i represents a natural number.

$$\begin{matrix}[ Mathematical Formula 2 ] & \\ C ( {x}_{i} ) = {\sum }_{j}^{J} {α}^{( j )} {\sum }_{m}^{M} {\sum }_{n}^{N} {Z}_{kn} & ( Equation 1 )\end{matrix}$$

Next, Equation 1 is described. The set of the jth-generation persons counted from the first person (the subject person) Xᵢ is defined as shown below. Here, j is a natural number. The number of jth-generation persons is M (M being a natural number).

X^{(i, j)}=(X^{(i, j)}₁,X^{(i, j)}₂,X^{(i, j)}₃, . . . ,X^{(i, j)}_{M})

Zₖₙ represents an element having k as the x-component and n as the y-component in the adjacency matrix Z. Here, k is expressed as: k=index(Xₘ^{(i, j)})). Meanwhile, index( ) represents a function that returns the index in the relationship list. In the following, index(Xₘ^{(i, j)}) is further described. In the relationship list, indexes “1” through “6” are assigned to the persons A through F, respectively. Here, index(Xₘ^{(i, j)}) returns the index associated with Xₘ^{(i, j)}. In a case where Xₘ^{(i, j)} is the person E, for example, index(Xₘ^{(i, j)}) returns “5” as the index.

Meanwhile, α^{(j)} is the coefficient by which a jth generation calculation result is to be multiplied. The coefficient α is set beforehand so as to become smaller as the value of a generation G becomes greater. For example, the coefficient α is the reciprocal of the value of a generation G. For example, the coefficient α for a person of the generation “1” is “1”, and the coefficient α for a person of the generation “2” is “0.5”. FIG. 10 shows the coefficients of persons of the respective generations. The manager of the influence calculation device 8, for example, determines up to which generation counted from the first person should be reflected in calculating influence scores. In this embodiment, the persons up to the second generation counted from the first person are reflected.

Also, a value D(Xᵢ) may be used in calculating C(Xᵢ), which is the influence score of the person Xᵢ, according to Equation 1. Dⱼ(Xᵢ) represents the total number of persons of the first through jth generations counted from the person Xᵢ. Consequently, the influence score of a person Xⱼ can also be expressed by Equation 2 shown below. Dⱼ(Xᵢ) is generated from the relationship list or the adjacency matrix Z.

$$\begin{matrix}[ Mathematical Formula 3 ] & \\ C ( {x}_{i} ) = {\sum }_{j}^{J} {α}^{( j )} \cdot {D}_{j} ( {X}_{i} ) & ( Equation 2 )\end{matrix}$$

In a case where the first person whose influence score is to be calculated is the person B, j is 2, α⁽¹⁾ is 1, and α⁽²⁾ is 0.5, for example, the influence score C(B) of the person B is calculated as shown below.

$$C ( B ) = {α}^{( 1 )} \times ( the number of persons of the first generation counted from the person B ) + {α}^{( 2 )} \times ( the number of persons of the first generation counted from the person B + the number of persons of the second generation counted from the person B ) = {α}^{( 1 )} \times ( 2 ) + {α}^{( 2 )} \times ( 2 + 3 ) = 1 \times ( 2 ) + 0.5 \times ( 5 ) = 4.5 \qquad ( Equation 3 )$$

It should be noted that the number of persons of the first generation is the number of second persons. Meanwhile, the number of persons of the second generation is the number of third persons. In Equation 3, “the number of persons of the first generation counted from the person B” is determined from a first communication history. The first communication history is a history of communication between the first person and a second person. The first acquiring unit 818 also acquires the first communication history. Meanwhile, “the number of persons of the second generation counted from the person B” is determined from a second communication history. The second communication history is a history of communication between the second person and a third person. The second acquiring unit 820 acquires the second communication history. In this manner, the first communication history and the second communication history are used in Equation 1 and Equation 2. That is, the calculating unit 824 calculates the influence scores of the respective persons, using the first communication history acquired by the first acquiring unit 818 and the second communication history acquired by the second acquiring unit 820.

FIG. 11 is a diagram showing the influence scores of the respective persons calculated by the calculating unit 824. In FIG. 11, an influence score is shown in the vicinity of each person. For example, the influence score of the person A is “2”, and the influence score of the person B is “4.5”.

After the calculating unit 824 calculates the influence scores of all the persons specified in the relationship list, the influence scores of all the persons are transmitted to the DB 6 via the communication IF 88 (see FIG. 2). The DB 6 stores the transmitted influence scores of all the persons as an influence score DB.

FIG. 12 is a table showing an example of the influence score DB. In the example shown in FIG. 12, domain names and the influence scores calculated for the respective persons by the calculating unit 824 are stored in the influence score DB. The domain names are specified by mail addresses assigned to the respective persons. As for the person A, “ppp.local” is stored as the domain, and “1.5” is stored as the influence score, for example. In this embodiment, a group name can be identified from a domain. For example, the group to which the persons having mail addresses with the domain “ppp.local” is group P. The group to which the persons having mail addresses with a domain “qqq.local” is group Q.

<Flowchart of a Process to be Performed by the Influence Calculation Device 8>

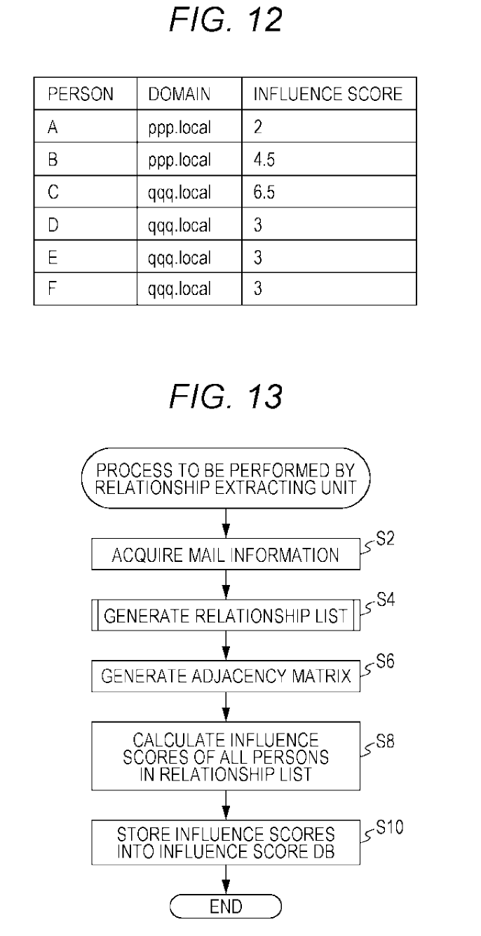

FIG. 13 shows a flowchart of a process to be performed by the influence calculation device 8. Referring now to FIG. 13, the flowchart of a process to be performed by the influence calculation device 8 is described. In S2, the relationship list generating unit 812 acquires mail information. In S4, in accordance with the acquired mail information, the relationship list generating unit 812 generates a relationship list (see FIG. 6). In S6, in accordance with the generated relationship list, the adjacency matrix generating unit 814 generates the adjacency matrix Z. In S8, in accordance with the relationship list and Equation 1, the calculating unit 824 calculates the influence scores of all the persons (the persons A through F) specified in the relationship list. As the influence calculation device 8 transmits the calculated influence scores of all the persons specified in the relationship list to the DB 6, the influence scores of all the persons are stored into the influence score DB in the DB 6.

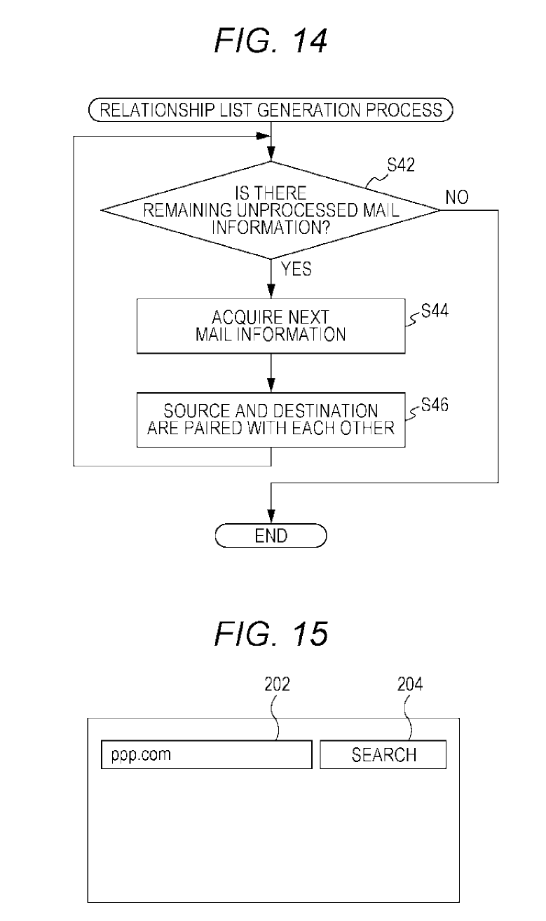

FIG. 14 shows a flowchart of the relationship list generation process (S4 in FIG. 13) to be performed by the relationship list generating unit 812. In S42, before generating the relationship list, the relationship list generating unit 812 determines whether there remains unprocessed mail information in the mail information that is equivalent to the predetermined period T and has been transmitted from the collection device 4. If the relationship list generating unit 812 determines that there remains unprocessed mail information (YES in S42), the process moves on to S44.

In S44, the relationship list generating unit 812 acquires the next mail information from the remaining unprocessed mail information in the mail information that is equivalent to the predetermined period T and has been transmitted from the collection device 4. In S46, the source and the destination indicated by the mail information acquired in S44 are paired with each other. As for the persons who have already been paired at the time of S46, no processing needs to be performed for them, and the processing in S46 is ended. If the relationship list generating unit 812 determines in S42, before generating the relationship list, that there remains no unprocessed mail information in the mail information that is equivalent to the predetermined period T and has been transmitted from the collection device 4 (NO in S42), the relationship list generating unit 812 ends the relationship list generation process.

In the above manner, the influence calculation device 8 of this embodiment calculates the influence score of a person (a first person), using not only the first communication history between the first person and a second person who has communicated with the first person within the predetermined period T, but also the second communication history between the second person and a third person. Thus, the influence calculation device 8 of this embodiment can calculate influence scores more accurately than in a conventional case where the second communication history is not used while the first communication history is used.

<Process to be Performed by the Display Device 10>

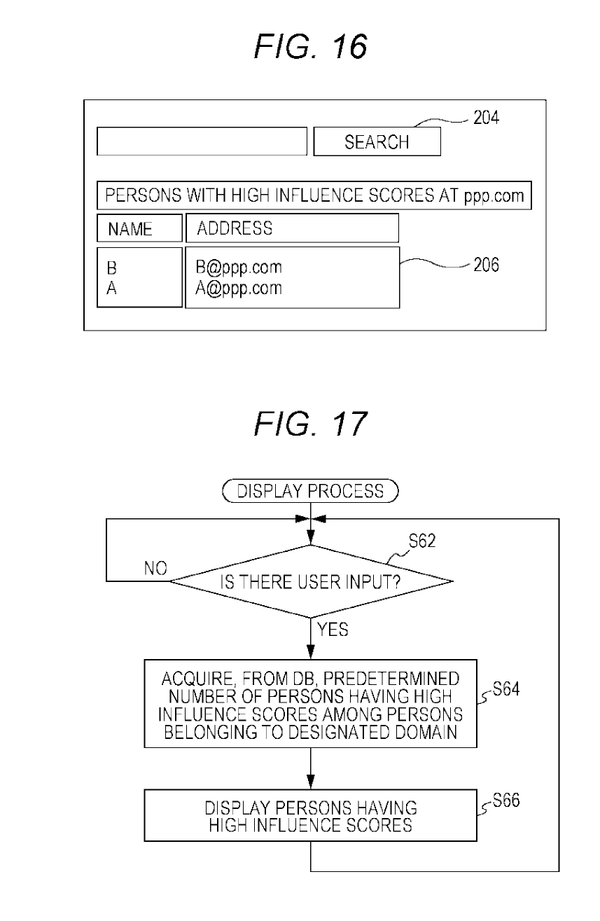

The display device 10 displays the influence score of each person, in accordance with information input from a user. Referring now to FIGS. 15 and 16, a process to be performed by the display device 10 is described. FIG. 15 shows an example of the input screen displayed by the display device 10. FIG. 16 shows an example of the influence score display screen displayed by the display device 10.

When the input screen shown in FIG. 15 is displayed, a user can input a group name. For example, a cursor (not shown) is moved onto an input region 202 on the input screen shown in FIG. 15, and a group name is then input. In this embodiment, a domain name corresponding to a group name can be input to the input region 202. When the cursor is moved onto the input region 202, a tab showing all the domain names is displayed, for example. As the user selects a domain name from among the domain names displayed in the tab, the selected domain name is input to the input region 202. When a search button 204 is clicked with the domain name having been input to the input region 202, the influence score display screen shown in FIG. 16 is displayed.

In the example case shown in FIG. 16, “ppp.com” is input as the domain name. In the example shown in FIG. 16, “persons with high influence scores at ppp.com” are displayed. As can be seen from the example shown in FIG. 16, in the group P, the person B has the highest influence score, and the person A has the second highest influence score. In the example shown in FIG. 16, mail addresses of the persons are also displayed along with the names of the persons.

FIG. 17 shows a flowchart of a process to be performed by the CPU 101 of the display device 10. In S62, the CPU 101 determines whether a group name (a domain name) has been input thereto by a user. While the input screen shown in FIG. 15 is displayed, the CPU 101 stands by until a group name is input by a user (NO in S62). If the CPU 101 determines that a group name has been input thereto by a user (YES in S62), the process moves on to S64. In S64, a predetermined number of influence scores of the persons belonging to the domain designated by the user are acquired from the DB 6 (or the influence score DB shown in FIG. 12). In this embodiment, the predetermined number is three. When the processing in S64 is completed, the process moves on to S66. In S66, the persons with high influence scores are displayed on the display 105 in accordance with the acquired influence scores, as shown in FIG. 16. As for the persons with high influence scores, the name of the person with the highest influence score is displayed at the top, and the names of the other persons are displayed at the positions corresponding to their influence scores.

With this configuration, a user can be made to recognize the persons with high influence scores in a group the user has input.

### Second Embodiment

Next, a second embodiment is described. The first embodiment has been described on the assumption that the influence scores of a person on the other persons are the same. For example, there may be two persons (a person X1 and a person X2) as persons having a relationship with a person X. In this case, the person X1 of the two persons may have a relationship with a large number of persons while the other person X2 has a relationship with a small number of persons. In this case, the person X1 and the person X2 should not be evaluated equally in terms of influence scores.

For example, the person X1 having a relationship with a large number of persons is influential on the persons specified in the relationship list. Therefore, the relationship between the person X and the person X1 has a higher possibility of increasing the influence of the person X in the network than the relationship between the person X and the person X2. The centricity index that reflects the persons having relationships with the persons X1 and X2 having relationships with the person X in calculating the influence score of the person X as above may be eigenvector centricity. In this embodiment, the influence score of each person is calculated with eigenvector centricity. Using eigenvector centricity is using the sum of the influence scores of the second persons (the persons who have communicated with the first person within the predetermined period T).

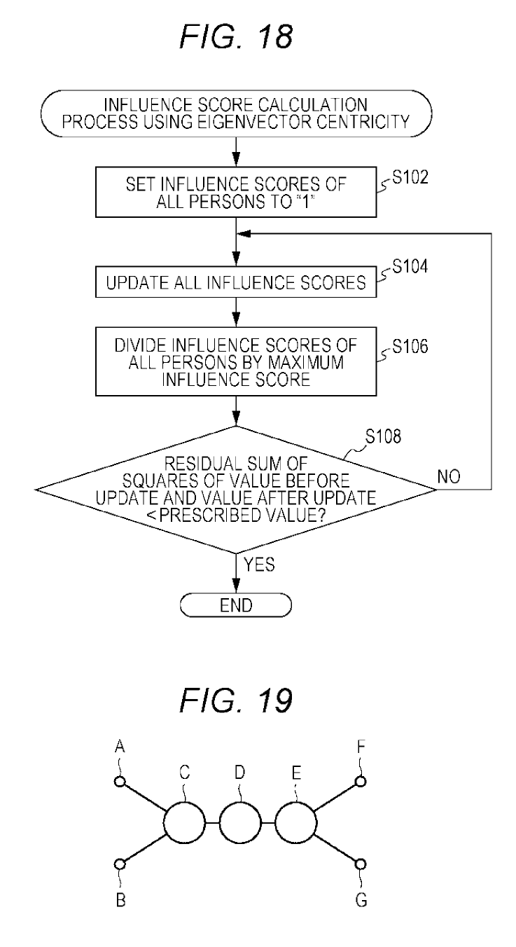

FIG. 18 is a flowchart of a process to be performed by the calculating unit 824 of the second embodiment. In S102, the calculating unit 824 sets the influence scores of all the persons (the persons A through F) specified in the relationship list to the initial values. Here, the initial value may be any value. In this embodiment, the initial value is “1”.

In S104, the calculating unit 824 updates the influence scores of all the persons A through F. In this embodiment, the calculating unit 824 updates the influence scores C1 of the persons A through F, using Equation 21 shown below.

$$\begin{matrix}[ Mathematical Formula 4 ] & \\ C 1 ( {x}_{i} ) = {\sum }_{j}^{N} {z}_{ij} C 1 ( {X}_{i} ) & ( Equation 21 )\end{matrix}$$

The set of N (six in this embodiment) persons specified in the relationship list is X=(X1, X2, X3, . . . , Xᵢ, . . . , X_{N}). Here, 1≦i≦N. For example, X₁ represents the person A, X₂ the person B, X₃ the person C, X₄ the person D, X₅ the person E, and X₆ the person F. Meanwhile, 1≦j≦N, and i≠j. In a modification, i may be equal to j (i=j). C1(Xᵢ) represents the influence score of a person i, and C1(Xⱼ) represents the influence score of a person j. In a case where i=2, for example, the influence score C1(X₂) is the influence score of the person X₂ or the person B. Zᵢⱼ is the element shown at the portion where the ith person and the jth person cross each other in the adjacency matrix Z shown in FIG. 7. For example, Z₃₄ is “1”.

When the processing in S104 is completed, the process moves on to S106. In S106, the calculating unit 824 divides the influence score updated in S104 by the maximum influence score. Here, the maximum influence score is the maximum value of the influence scores of all the persons updated in S104. In S108, a check is made to determine whether the influence scores of all the persons have converged. In S108 in this embodiment, if the residual sum of squares of the influence score before the update in S104 and the influence score after the update in S104 is determined to be smaller than a prescribed value, the influence scores of all the persons are determined to have converged. The residual sum of squares is expressed by Equation 22 shown below, for example.

$$\begin{matrix}[ Mathematical Formula 5 ] & \\ {\sum }_{i}^{N} \{ C 1 {( {x}_{i} )}^{′} - {( C 1 ( {X}_{i} ) \}}^{2} & ( Equation 22 )\end{matrix}$$

Here, C1(Xᵢ)′ represents the influence score of a person X, before the update in S104, and C1(Xᵢ) represents the influence score of the person X, after the update in S104.

According to this embodiment, the influence score of the first person can be calculated, with the influence scores of the second persons being taken into account. Thus, the influence score of the first person can be more accurately calculated.

In this embodiment, eigenvector centricity is applied as shown in FIG. 18 and Equation 22. However, some other method may be used, as long as eigenvector centricity can be applied.

### Third Embodiment

Next, a third embodiment is described. In the third embodiment, the influence score of a first person is calculated with the use of the betweenness centrality of the first person. Here, betweenness centrality is a value that indicates how well the person is functioning as a contact or a hub in the network. The calculating unit 824 calculates the betweenness centrality B(Xᵢ) of the person Xᵢ, using Equation 31 shown below.

$$\begin{matrix}[ Mathematical Formula 6 ] & \\ B ( {X}_{i} ) = {\sum }_{r \neq i} {\sum }_{s \neq i} \frac{{σ}_{rs} ( {x}_{i} )}{{σ}_{rs}} & ( Equation 31 )\end{matrix}$$

In Equation 31, 1≦r≦N, and 1≦s≦N. In the network, σᵣₛ represents the total number of the shortest paths between a person r and a person s, and σᵣₛ(Xᵢ) represents the total number of the shortest paths between the person r and the person s among the paths extending through the person Xᵢ.

FIG. 19 is a diagram for explaining the concept of betweenness centrality. In the example shown in FIG. 19, the network is different from the network shown in FIG. 8, and persons A through G are shown. In FIG. 19, a larger circle indicates a higher degree of betweenness centrality. Specifically, in FIG. 19, the person C, the person D, and the person E have a high degree of betweenness centrality, and the person A, the person B, the person F, and the person G have a low degree of betweenness centrality. In the example shown in FIG. 19, the person C, the person D, and the person E form an information transmission/reception path (a contact or a hub) in the network, and have a high degree of betweenness centrality.

The calculating unit 824 calculates the betweenness centrality of each of the persons A through G, using Equation 31. The calculating unit 824 calculates the influence score of each person, using the calculated betweenness centrality. For example, an equation formed by substituting Dⱼ(Xᵢ) in Equation 2 described in the first embodiment with B(Xᵢ) calculated by Equation 31 may be used in calculating an influence score. Alternatively, the calculating unit 824 may calculate an influence score by setting the initial value described in S102 in FIG. 18 of the second embodiment as B(Xᵢ) calculated by Equation 31. Therefore, in the third embodiment, the first communication history and the second communication history include the betweenness centrality (or the value of the betweenness centrality) of each person.

As described above, the calculating unit 824 of the third embodiment calculates the influence score of each person in accordance with betweenness centrality and the like. Thus, in the third embodiment, the influence score of each person can be calculated, with the betweenness centrality of the person being taken into account.

### Fourth Embodiment

In the adjacency matrix Z of the first embodiment, “1” is set, regardless of whether the number of times communication has been performed between persons is one. In a fourth embodiment, on the other hand, the calculating unit 824 calculates influence scores, using an adjacency matrix Z1 that reflects the number of times communication has been performed.

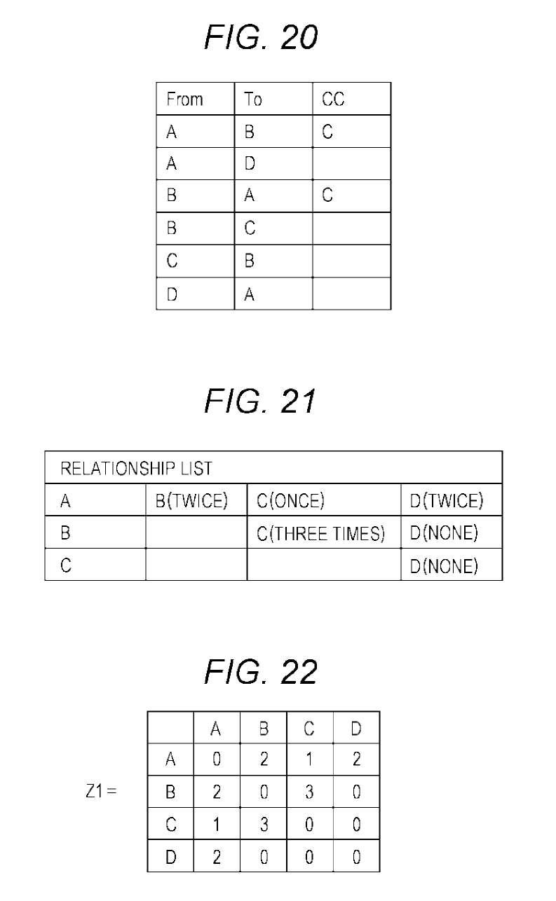

FIG. 20 shows communication histories of persons A through D. In FIG. 20, the person A has transmitted e-mail to the person B under “To”, and transmitted the e-mail to the person C under “CC (Carbon Copy)”. In the example shown in FIG. 20, the number of times communication has been performed between the person A and the person B is two. The number of times communication has been performed between the person A and the person C is one. The number of times communication has been performed between the person A and the person D is two.

The mail information acquired by the relationship list generating unit 812 in the predetermined period T is the mail information shown in FIG. 20. In accordance with the mail information, the relationship list generating unit 812 generates a relationship list. FIG. 21 is a table showing an example of the relationship list. The example in FIG. 21 shows that the number of times communication has been performed between the person A and the person B is two, the number of times communication has been performed between the person A and the person C is one, and the number of times communication has been performed between the person A and the person D is two.

In accordance with the generated relationship list, the adjacency matrix generating unit 814 generates the adjacency matrix Z1. FIG. 22 shows the adjacency matrix Z1 in the form of a table. The adjacency matrix Z1 generated by the adjacency matrix generating unit 814 is input to the calculating unit 824. The calculating unit 824 calculates influence scores in accordance with the adjacency matrix Z1. For example, the calculating unit 824 calculates influence scores, using an equation formed by substituting Zₖₙ in Equation 1 with Z1ₖₙ. In the fourth embodiment, the first communication history includes the number of times communication has been performed between a first person and a second person. The second communication history includes the number of times communication has been performed between the second person and a third person. Alternatively, the first communication history and the second communication history may include the number of times communication has been performed between the first person and a second person, and the number of times communication has been performed between the second person and a third person.

According to the fourth embodiment, the calculating unit 824 can calculate influence scores that reflect the numbers of times communication has been performed. Thus, in the fourth embodiment, the influence score of each person can be calculated, with the number of times the person has performed communication being taken into account.

### Fifth Embodiment

In the first embodiment, the influence scores of the respective persons are calculated, with the numbers of destinations of transmission the respective persons have performed not being taken into account. When e-mail has been transmitted to a large number of destinations, the relationship between the transmitter of the e-mail and a recipient of the e-mail is normally weaker than that in a case where e-mail has been transmitted to only one destination. In view of this, influence scores are calculated in this embodiment, with the number of transmission destinations being taken into account.

In this embodiment, the mail information acquired by the relationship list generating unit 812 in the predetermined period T is the mail information shown in FIG. 20. In accordance with the relationship list supplied from the relationship list generating unit 812, the adjacency matrix generating unit 814 generates an adjacency matrix. The relationship list of this embodiment is shown in FIG. 21. In a case where there is e-mail transmitted to two or more destinations, the adjacency matrix generating unit 814 multiplies the elements corresponding to the transmission by a coefficient. Here, the coefficient is such a coefficient that becomes smaller as the number of destinations to which the e-mail has been transmitted becomes larger. In this embodiment, the coefficient is the reciprocal of the number of destinations. It should be noted that some other method may be used in determining the coefficient. In the example shown in FIG. 21, the person A has transmitted e-mail to the person B and the person C. Therefore, the transmission of the e-mail from the person A to the person B, and the transmission of the d-mail from the person A to the person C are set as ½.

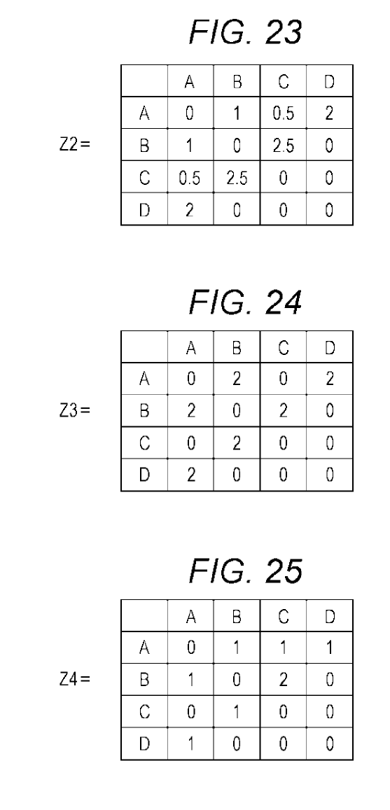

FIG. 23 shows an adjacency matrix Z2 to be used in the fifth embodiment in the form of a table. The calculating unit 824 calculates influence scores in accordance with the adjacency matrix Z2. For example, the calculating unit 824 calculates influence scores, using an equation formed by substituting Zₖₙ in Equation 1 with Z2ₖₙ. In the fifth embodiment, the first communication history includes the number of second persons as destinations to which the first person has transmitted e-mail. The second communication history includes the number of third persons as destinations to which a second person has transmitted e-mail. Alternatively, the first communication history and the second communication history may include the number of second persons as destinations to which the first person has transmitted e-mail, and the number of third persons as destinations to which a second person has transmitted e-mail.

According to the fifth embodiment, the calculating unit 824 can calculate influence scores that reflect the numbers of destinations. Thus, in the fifth embodiment, the influence score of each person can be calculated, with the number of destinations of transmission performed by the person being taken into account.

### Sixth Embodiment

In the first embodiment, the influence scores of the respective persons are calculated, with the types of destinations of transmission not being taken into account. Normally, types of destinations of e-mail transmission include “TO”, “CC”, and “BCC”. An e-mail transmission destination under “TO” is a “main transmission destination”, and an e-mail transmission destination under “CC” or “BCC” is a “sub transmission destination”. Where e-mail having its destination under “TO” is compared with e-mail having its destination under “CC” or “BCC”, the relationship between the transmitter of the e-mail having its destination under “TO” and the receiver of the e-mail is stronger than that between the transmitter of the e-mail having its destination under “CC” or “BCC” and the receiver of the e-mail. In view of this, influence scores are calculated in this embodiment, with the types of transmission destinations being taken into account.

In this embodiment, the mail information acquired by the relationship list generating unit 812 in the predetermined period T is the mail information shown in FIG. 20. In accordance with the relationship list supplied from the relationship list generating unit 812, the adjacency matrix generating unit 814 generates an adjacency matrix. The relationship list of this embodiment is shown in FIG. 21. In a case where there is e-mail transmitted to two or more destinations, the adjacency matrix generating unit 814 extracts the types of the destinations of the e-mail. In the example shown in FIG. 20, the person A has transmitted e-mail to the person B as a destination under “TO”, and transmitted the e-mail to the person C as a destination under “CC”. In this case, the adjacency matrix generating unit 814 multiplies the element indicating that e-mail has been transmitted from the person A to the person B (the main transmission destination) by a coefficient α^{TO}. The adjacency matrix generating unit 814 also multiplies the element indicating that e-mail has been transmitted from the person A to the person C (the sub transmission destination) by a coefficient α^{CC}. Here, α^{TO}>α^{CC}. For example, α^{TO} may be “1”, while α^{CC} is “0.8”. In this example, α^{TO} is “1”, and α^{CC} is “0”.

Consequently, the adjacency matrix generating unit 814 generates an adjacency matrix by extracting only the e-mail transmission destinations under “TO”.

FIG. 24 shows an adjacency matrix Z3 to be used in the sixth embodiment in the form of a table. The calculating unit 824 calculates influence scores in accordance with the adjacency matrix Z3. For example, the calculating unit 824 calculates influence scores, using an equation formed by substituting Zₖₙ in Equation 1 with Z3ₖₙ. In the sixth embodiment, the first communication history includes the type of a second person as a destination to which the first person has transmitted e-mail. The second communication history includes the type of a third person as a destination to which a second person has transmitted e-mail. Alternatively, the first communication history and the second communication history may include the type of a second person as a destination from the first person, and the type of a third person as a destination from a second person.

According to the sixth embodiment, the calculating unit 824 can calculate influence scores that reflect the types of destinations. Thus, in the sixth embodiment, the influence score of each person can be calculated, with the types of destinations of transmission performed by the person being taken into account.

### Seventh Embodiment

In the fourth embodiment described above, the calculating unit 824 calculates influence scores, using the adjacency matrix Z1 that reflects the number of times communication has been performed. In a seventh embodiment, the calculating unit 824 calculates influence scores, using an adjacency matrix Z4 that reflects the number of times transmission has been performed but does not reflect the number of times reception has been performed in the number of times communication has been performed. For example, if information to spread across the network is transmitted to a person who has performed transmission a large number of times (or a person who frequently transmits e-mail), the information can appropriately spread across the entire network. In other words, the number of times transmission has been performed can be regarded as an index of easiness of information transmission in the network. In view of this, influence scores are calculated in this embodiment, with the number of times transmission has been performed being taken into account.

In this embodiment, the mail information acquired by the relationship list generating unit 812 in the predetermined period T is the mail information shown in FIG. 20. In accordance with the relationship list supplied from the relationship list generating unit 812, the adjacency matrix generating unit 814 generates an adjacency matrix. The relationship list of this embodiment is shown in FIG. 21. The adjacency matrix generating unit 814 also extracts the number of times transmission from the first person to other persons has been performed. In the example shown in FIG. 20, the person A has transmitted e-mail to the person B, the person C, and the person D once each.

FIG. 25 shows the adjacency matrix Z4 to be used in the seventh embodiment in the form of a table. The calculating unit 824 calculates influence scores in accordance with the adjacency matrix Z4. For example, the calculating unit 824 calculates influence scores, using an equation formed by substituting Zₖₙ in Equation 1 with Z4ₖₙ. In the seventh embodiment, the first communication history includes the number of times transmission from the first person to a second person has been performed. The second communication history includes the number of times transmission from the second person to a third person has been performed. Alternatively, the first communication history and the second communication history may include the number of times transmission from the first person to a second person has been performed, and the number of times transmission from the second person to a third person has been performed.

According to the seventh embodiment, the calculating unit 824 can calculate influence scores that reflect the numbers of times transmission has been performed. Thus, in the seventh embodiment, the calculating unit 824 can calculate influence scores that reflect easiness of information transmission in the network.

### Eighth Embodiment

In the seventh embodiment described above, the calculating unit 824 calculates influence scores, using an adjacency matrix Z4 that reflects the number of times transmission has been performed but does not reflect the number of times reception has been performed in the number of times communication has been performed. In an eighth embodiment, on the other hand, the calculating unit 824 calculates influence scores, using an adjacency matrix Z5 that reflects the number of times reception has been performed but does not reflect the number of times transmission has been performed in the number of times communication has been performed. For example, a person who has received e-mail a large number of times (a person who frequently receives e-mail) is a person who has various kinds of information. In view of this, influence scores are calculated in this embodiment, with the number of times e-mail has been received being taken into account.

In this embodiment, the mail information acquired by the relationship list generating unit 812 in the predetermined period T is the mail information shown in FIG. 20. In accordance with the relationship list supplied from the relationship list generating unit 812, the adjacency matrix generating unit 814 generates an adjacency matrix. The relationship list of this embodiment is shown in FIG. 21. The adjacency matrix generating unit 814 also extracts the number of times the first person has received e-mail from another person. In the example shown in FIG. 20, the person A has received e-mail from the person B and the person D once each.

Meanwhile, the adjacency matrix Z5 (now shown) is a transposed matrix Z4^{T} of the adjacency matrix Z4. The adjacency matrix generating unit 814 may generate the adjacency matrix Z5, in accordance with the relationship list supplied from the relationship list generating unit 812. The adjacency matrix generating unit 814 also generates the adjacency matrix Z4, and further generates the transposed matrix Z4^{T} of the adjacency matrix Z4 as the adjacency matrix Z5.

According to the eighth embodiment, the calculating unit 824 can calculate influence scores that reflect the numbers of times reception has been performed. Thus, in the eighth embodiment, the calculating unit 824 can calculate influence scores that reflect how wide the variety of information (as to the conditions of the entire network and the like) held by each person.

[Influence Score Display in Cases Where At Least One of the Fourth Through Eighth Embodiments is Applied]

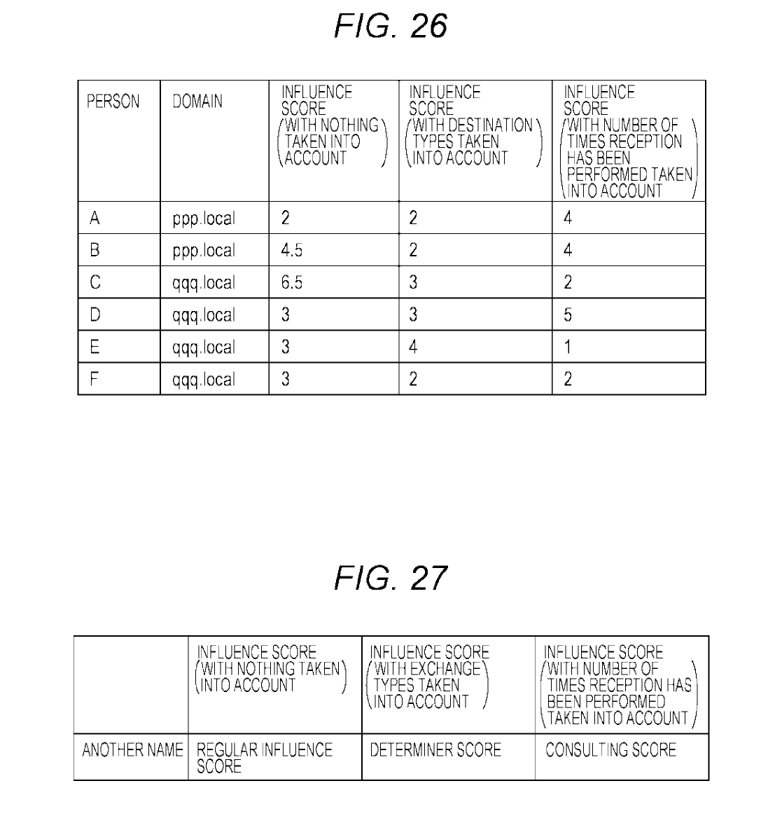

Next, influence score display by the display device 10 in a case where at least one of the fourth through eighth embodiments is applied is described. First, the influence score DB in a case where at least one of the fourth through eighth embodiments is applied is described. FIG. 26 is a diagram showing an example of the influence score DB in a case where at least one of the fourth through eighth embodiments is applied.

The influence score DB shown in FIG. 26 stores not only the influence score DB shown in FIG. 12 (the influence score DB that takes nothing into account as shown in FIG. 26), but also an influence score DB that takes the types of destinations into account, and an influence score DB that takes into account the number of times reception has been performed. The influence score DB that takes account the types of destinations is an influence score DB that stores the influence scores of the respective persons calculated in the sixth embodiment. The influence score DB that takes account the number of times reception has been performed is an influence score DB that stores the influence scores of the respective persons calculated in the eighth embodiment. It should be noted that the respective influence scores shown in FIG. 26 are not communication histories of the respective persons A through D shown in FIG. 20, but are calculated with respect to other communication histories (not shown) of the respective persons A through D.

Other names are also given to influence scores in accordance with the items taken into account. FIG. 27 is a table showing the correspondence between influence scores and other names given to the influence scores. The other names are stored in the DB 6. In the example shown in FIG. 27, another name for “influence score with nothing taken into account” is defined as “regular influence score”. Another name for “influence score with destination types taken into account” is defined as “determiner score”. Further, another name for “influence score with number of times reception has been performed taken into account” is defined as “consulting score”.

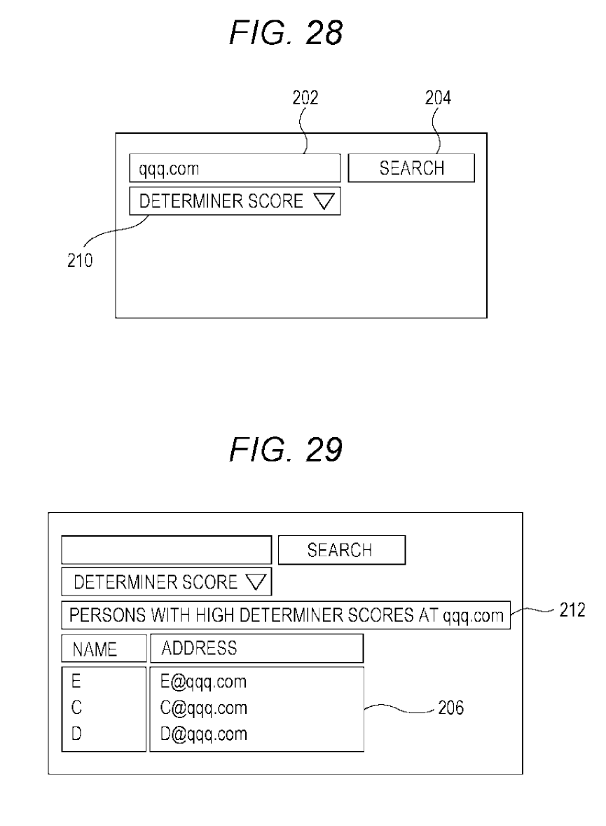

FIG. 28 is a diagram showing an example of the input screen to be displayed by the display 105 in a case where at least one of the fourth through eighth embodiments is applied. The input screen shown in FIG. 28 is the same as the input screen shown in FIG. 15, except that a search standpoint input region 210 to which the user can also input a search standpoint is also provided. The search standpoint input region 210 is a region to which the user can input a search standpoint. A search standpoint is a standpoint of an influence score to be displayed. The search standpoints of this embodiment correspond to the other names for the influence scores shown in FIG. 27.

For example, when the cursor is moved onto the search standpoint input region 210, a tab showing all the search standpoints (or the other names shown in FIG. 27) is displayed. As the user selects a search standpoint from among the search standpoints displayed in the tab, the selected search standpoint is input to the search standpoint input region 210. When the search button 204 is clicked with the domain name having been input to the input region 202 and the search standpoint having been input to the search standpoint input region 210, the influence score display screen shown in FIG. 29 is displayed.

FIG. 29 shows an example case where “qqq.com” is input as the domain name, and “determiner score” is input as the search standpoint. In the example shown in FIG. 29, “persons with high determiner scores at qqq.com” are displayed. In the example shown in FIG. 29, the person E, the person C, and the person D have higher determiner scores in this order in the group Q.

As described above, with influence score display in a case where at least one of the fourth through eighth embodiments is applied, it is possible to display influence scores at search standpoints input by users. Thus, the user can be made to recognize more minute influence scores.

### Modifications

The present invention is not limited to the above embodiments, and various other changes and modifications can be made. In the description below, modifications that can be applied to the present invention are described.

[Dⱼ(Xᵢ)]

In the first embodiment, Dᵢ(Xᵢ) represents the total number of persons of the first through jth generations counted from the person Xᵢ. Alternatively, Dⱼ(Xᵢ) may represent the number of persons of the jth generation counted from the person Xᵢ, and does not include the number of persons of the first through (j−1)th generations.

In the case of such a configuration, Equation 3 for calculating the influence score of the person B turns into Equation 3′ shown below.

$$C ( B ) = {α}^{( 1 )} \times ( the number of persons of the first generation counted from the person B ) + {α}^{( 2 )} \times ( the number of persons of the second generation counted from the person B ) = {α}^{( 1 )} \times ( 2 ) + {α}^{( 2 )} \times ( 0 + 3 ) = 1 \times ( 2 ) + 0.5 \times ( 3 ) = 3.5 \qquad ( Equation {3}^{′} )$$

Alternatively, Dⱼ(Xᵢ) may represent the number of persons of the jth generation counted from the person Xᵢ, and not include the number of persons of the first through (j−1)th generations. With such a configuration, the amount of calculation can be made smaller than that in the case with Equation 3.

### Combinations of the Embodiments

Of the embodiments described above, at least two embodiments may be used. For example, the influence score C(Xᵢ) of the first person calculated according to Equation 1 or Equation 2 described in the first embodiment may be made to reflect the influence score C1(Xᵢ) of the first person calculated according to Equation 21 described in the second embodiment. Here, the calculating unit 824 may calculate the influence score of the first person, using one of the reflection formulas described below as a method of causing the reflection. According to a reflection formula, C(Xᵢ) may be multiplied by C1(Xᵢ). According to another reflection formula, C1(Xᵢ) may be added to C(Xᵢ). Further, any reflection formula may be employed, as long as the reflection formula can cause C(Xᵢ) to reflect C1(Xᵢ).

For example, the influence score C(Xᵢ) of the first person calculated according to Equation 1 or Equation 2 described in the first embodiment may be made to reflect the betweenness centrality B(Xᵢ) of each person described in the third embodiment. Here, the calculating unit 824 may calculate the influence score of the first person, using one of the reflection formulas described below as a method of causing the reflection. According to a reflection formula, C(Xᵢ) may be multiplied by B(Xᵢ). According to another reflection formula, B(Xᵢ) may be added to C(Xᵢ). Further, any reflection formula may be employed, as long as the reflection formula can cause C(Xᵢ) to reflect B(Xᵢ).

[Influence Scores]

In the above described embodiments, an influence score is “the influence score of the subject person on the other persons (five persons) among all the persons specified in the relationship list. However, an influence score may not necessarily be such a concept, and may be some other concept. For example, an influence score may be any concept, as long as it is the influence score of the first person on multiple persons including the second person and the third person. The multiple persons may include the first person. Alternatively, the group to which the first through third persons belong may include a person with which any of the first through third persons has not communicated in the predetermined period T.

[Information to Be Used for Calculating Influence Scores]

(1) In the above described embodiments, the information to be used for calculating an influence score is the first communication history and the second communication history. However, the calculating unit 824 may calculate an influence score, using information related to neither the first communication history nor the second communication history. That is, the calculating unit 824 may calculate an influence score in accordance with calculation information including the first communication history and the second communication history.

In the above described second embodiment, eigenvector centricity can be regarded as a concept included neither in the first communication history not in the second communication history. In the present invention, eigenvector centricity is a concept included neither in the first communication history nor in the second communication history, but is included in the calculation information. Therefore, even though eigenvector centricity is a concept included neither in the first communication history nor in the second communication history, the calculating unit 824 calculates an influence score in accordance with the calculation information including the eigenvector centricity. Also, even if at least one of the concepts (the number of times communication has been performed, for example) described in the third through eighth embodiments is a concept included in neither the first communication history nor the second communication history, the calculating unit 824 calculates an influence score in accordance with the at least one of the concepts. Further, the calculation information including the first communication history and the second communication history may be “a communication history including the first communication history and the second communication history”.

(2) The first acquiring unit 818 may acquire the first communication history of the subject person (the first person) with respect to each of the other persons specified in the relationship list. The second acquiring unit 820 may acquire the second communication history of a person who communicates with the subject person (the first person), with respect to each of the other persons specified in the relationship list.

(3) In the above described embodiments, the calculating unit 824 calculates an influence score that reflects the persons up to the second generation counted from the first person. However, the calculating unit 824 may calculate an influence score that reflects the persons up to the Lth (L being an integer of 3 or greater) generation, using Equation 1. With such a configuration, it is possible to calculate a more accurate influence score.

(4) In the first embodiment, when an influence score is calculated, the calculation result is multiplied by the coefficient a corresponding to the generation, as shown in Equation 1 or Equation 2. However, the multiplication using the coefficient a may not be performed. With such a configuration, the process of multiplication using the coefficient a is skipped, and the number of processes can be reduced accordingly.

[Persons Whose Influence Scores Are Calculated]

In the above described embodiments, the influence scores of all the persons specified in the relationship list are calculated. However, instead of the influence scores of all the persons, the influence score of a predetermined person of all the persons may be calculated. The predetermined person may be designated by a user, for example. In such a configuration, only the influence score of the person whose influence score the user wishes to know is calculated. Accordingly, the amount of processing in influence score calculation is smaller than that in an influence calculation device that calculates the influence scores of all the persons.

[Other Aspects]

The essential aspect of the present invention can be regarded as software stored in a flash memory or some other recording medium, or software that can be downloaded via a network. The recording medium may not necessarily be a DVD-ROM, a CD-ROM, an FD, or a hard disk, but may be a medium that carries a program in a static manner, such as a magnetic tape, a cassette tape, an optical disk, an optical card, a mask ROM, an EPROM, an EEPROM, or a semiconductor memory like a flash ROM. Alternatively, the recording medium is a non-transitory medium from which the program and the like can be read by a computer. Meanwhile, the program herein may not be a program that can be directly executed by the CPU, but may be a program in a source program format, a compressed program, an encrypted program, or the like.

Although embodiments of the present invention have been described and illustrated in detail, it is clearly understood that the same is by way of illustration and example only and not limitation, the scope of the present invention should be interpreted by terms of the appended claims. It should be understood that equivalents of the claimed inventions and all modifications thereof are incorporated herein. Further, the inventions described in the embodiments and the respective modifications are intended to be carried out independently of one another or in combination, wherever possible.

What is claimed is:

1. A non-transitory recording medium storing a computer readable influence calculation program for causing a computer to perform:
acquiring a first communication history between a first person and a second person;
acquiring a second communication history between the second person and a third person; and
calculating an influence score of the first person on a plurality of persons including the second person and the third person, in accordance with information including the first communication history and the second communication history.

2. The non-transitory recording medium storing a computer readable influence calculation program according to claim 1, wherein the information includes the number of the second persons and the number of the third persons.

3. The non-transitory recording medium storing a computer readable influence calculation program according to claim 1, wherein the information includes a value obtained by multiplying the number of the second persons by a first coefficient, and a value obtained by multiplying the number of the third persons by a second coefficient, the second coefficient being smaller than the first coefficient.

4. The non-transitory recording medium storing a computer readable influence calculation program according to claim 1, wherein the information includes a sum of influence scores of the second person on the plurality of persons.

5. The non-transitory recording medium storing a computer readable influence calculation program according to claim 1, wherein the information includes betweenness centrality of the first person.

6. The non-transitory recording medium storing a computer readable influence calculation program according to claim 1, wherein the information includes the number of times communication has been performed between the first person and the second person, and the number of times communication has been performed between the second person and the third person.

7. The non-transitory recording medium storing a computer readable influence calculation program according to claim 1, wherein the information includes the number of times transmission from the first person to the second person has been performed, and the number of times transmission from the second person to the third person has been performed.

8. The non-transitory recording medium storing a computer readable influence calculation program according to claim 1, wherein the information includes the number of times reception from the second person has been performed by the first person, and the number of times reception from the third person has been performed by the second person.

9. The non-transitory recording medium storing a computer readable influence calculation program according to claim 1, wherein the information includes the number of destinations from the first person to the second person, and the number of destinations from the second person to the third person.

10. The non-transitory recording medium storing a computer readable influence calculation program according to claim 1, wherein the information includes the number of types of destinations from the first person to the second person, and the number of types of destinations from the second person to the third person.

11. An influence calculation device comprising:
a hardware processor that:
acquires a first communication history between a first person and a second person;
acquires a second communication history between the second person and a third person; and
calculates an influence score of the first person on a plurality of persons including the second person and the third person, in accordance with information including the first communication history and the second communication history.
